(19) United States
(12) Patent Application Publication
(10) Pub. No.: US 2010/0033988 A1
(43) Pub. Date: Feb. 11, 2010

(54) EDGE LIGHTING BACK LIGHT UNIT

(76) Inventors: Kuan-Her Chiu, Hsinchu Hsien (TW); Irene Chen, Hsinchu Hsien (TW)

Correspondence Address: NORTH AMERICA INTELLECTUAL PROPERTY CORPORATION, P.O. BOX 506, MERRIFIELD, VA, 22116, US

(21) Appl. No.: 12/535,705

(22) Filed: Aug. 5, 2009

(30) Foreign Application Priority Data
Aug. 11, 2008 (TW) 097130612

(51) Int. Cl. F21V 8/00; F21V 7/04

(52) U.S. Cl. 362/619; 362/615; 362/628

(57) ABSTRACT

An edge lighting back light unit (BLU) includes at least a point illuminant, a light guide unit, and a light guide plate. The light guide unit includes a plurality of micro-structures for breaking the total reflection inside the light guide unit to generate a uniform linear light illuminating outside the light guide unit. Then, the light guide plate could reflect the light from the linear illuminant to form a uniformly planar illuminant. The edge lighting BLU in the present invention could reduce the components, lower the temperature, and avoid the light mura.

### BACKGROUND OF THE INVENTION

1. Field of the Invention

The present invention relates to a back light unit, and more particularly, to an edge lighting back light unit (BLU).

2. Description of the Prior Art

With progress in electronic technology and the popularization of portable electronic devices in daily life, demands for display of light weight and low power consumption have been increased. Therefore the liquid crystal display (LCD) has gradually replaced the cold cathode tube (CRT) display in modern information products such as portable computers, mobile phones and personal digital assistants (PDA), based on its advantages of low power consumption, low heat emissions, light weight and non-radiative.

Because liquid crystals are not self-illuminant, back light unit (BLU) is provided to enable the display function. A conventional BLU includes an illuminant/light source and a light guide plate. The illuminant is positioned corresponding to the light guide plate, and the light guide plate is to guide the distribution of the light from the illuminant. Thus the point illuminant is transformed into a planar illuminant by the light guide plate.

It is well-known that conventional illuminant includes the cold cathode fluorescent lamp (CCFL) and the light emitting device (LED). Though the CCFL possesses good luminance, it makes the BLU suffers uneven light emission because the luminance at two ends of the CCFL is inferior to that at center of the CCFL. The CCFL also suffers inconvenience when being adapted to a portable display because it must be provided with high voltages and alternating currents. Furthermore, it is found that alternating currents adversely affect image signals of the LCD. The CCFL further has disadvantages of lower light utilization efficiency due to its cylinder shape and short life cycle due to its susceptibility to temperature. In addition, the LCD adapted with the CCFL has higher cost.

Accordingly, LED or other point illuminants accompanying with light guide bar have been developed to serve as the linear illuminant in order to overcome the abovementioned disadvantages of the CCFL. Examples of references include Taiwan Patent No. 534326 issued on May 21, 2003, Taiwan Patent No. 507099 issued on Oct. 21, 2002, and China Patent Application No. 99103941.6 issued on Sep. 13, 2000. However, the prior arts as mentioned above still possess drawbacks such as inferior coupling efficiency of the light guide bar with the point illuminants, complicated design of the light guide bar, and inferior illumination uniformity.

The LED BLU on the present market is constructed by LED light bar flexible printed circuit board (PCB), which is attached to a metal board by a thermal paste. And by shrinking individual LED and thinning the light guide plate, the BLU can have thinner dimension. In the construction, light is transported to the light guide plate from a linear illuminant, which is formed by arranging the LEDs in a straight line. When the light is emitted from the light guide plate, a planar illuminant is obtained.

However, the BLU requires a large number of LEDs, accordingly component failure rate is increased. Furthermore, optical anomaly is easily resulted because the linear illuminant is formed by arranging the plurality of point illuminants, which are the LEDs, in a straight line. Additionally, the arrangement of the LEDs has drawbacks such as poor heat dissipation and complicated assembling processes.

### SUMMARY OF THE INVENTION

One aspect of the present invention is to provide an edge lighting BLU for achieving goals that the conventional edge lighting BLU cannot.

According to one aspect of the present invention, an edge lighting BLU is provided. The edge lighting BLU comprises at least a point illuminant, a light guide unit and a light guide plate. The light guide unit has a plurality of micro-structures for breaking the total reflection inside the light guide unit to generate a light illuminating outside the light guide unit. A spatial distribution of the plurality of micro-structures is corresponding to a luminous intensity distribution of the point illuminant, thus the point illuminant is transformed into a uniformly linear illuminant. Thereafter, the light guide plate reflects the light from the linear illuminant, and thus the linear illuminant is transformed into a planar illuminant.

The light guide unit can be a column-shaped light guide unit, and comprises optical fiber, glass, Polymethylmethacrylate (PMMA) or Polycarbonate (PC). In order to obtain a uniform light emitted from the linear illuminant, an area of each micro-structure is inversely proportional to a luminous intensity distribution in the light guide unit. It also can be realized that when a density distribution of the micro-structures, which are identical with each other, is inversely proportional to the luminous intensity distribution in the light guide unit to obtain the uniform light emitted from the light guide unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a light guide unit of a BLU of the present invention;

FIG. 2A is a stereogram drawing illustrating different geometric shapes of the light guide unit of the BLU of the present invention;

FIGS. 2B, 2C and 2D are schematic drawings illustrating spatial distributions of the micro-structures of the present invention;

FIGS. 3A, 3B, 3C and 3D are schematic drawings illustrating geometric structure of the micro-structures of the present invention;

FIG. 4 is a schematic drawing illustrating a spatial distribution of the micro-structures of the present invention;

FIG. 5 is a stereogram drawing of a linear illuminant of the present invention;

FIGS. 6A, 6B, and 6C are schematic drawings of an edge lighting BLU of the present invention;

FIG. 6D is a cross section diagram showing a BLU of the present invention; and

FIG. 7 is a schematic drawing illustrating distributions of heat sources of a LCD of the present invention.

### DETAILED DESCRIPTION

The present invention is to provide an edge lighting BLU. In the following, detailed description along with the accompanied drawings is given to better explain preferred embodiments of the present invention but not limited to this. On the other hand, details well-known to those skilled in the art is omitted to avoid unnecessary limitation. Embodiments are provided so that this disclosure will be thorough and complete. However, the present invention can be embodied in many different forms and should not be construed as limited to the embodiments set forth herein. It is to be understood that both the foregoing general description and the following detailed description are exemplary and explanatory only and are not restrictive of the invention, as claimed.

U.S. Pat. No. 6,655,825 discloses a white light source for LCD backlight. The white light source is provided by mixing red, green and blue lights in the first end of an optical fiber to produce white light and then conducting the white light out of the second end of the optical fiber to the LCD. The color mixing optical fiber may be located remotely from the LCD. By mixing the red, green and blue lights, the white light is produced in the color mixing optical fiber, which is coupled to the LCD. Thus a construction of a backlight system is obtained.

U.S. Pat. No. 7,168,841 discloses a backlight module having independent light source. The backlight module includes a light generation device, a light transmission device, a light mixing device and a planar light generation device. The light generation device includes one or more light emitting components. The light transmission device is adopted for receiving and transmitting the light emitted by the light generation device. The light mixing device is adopted for mixing the light emitted by the light transmission device to generate a mixed linear light. The planar light generation device comprises a light distributing portion for receiving the mixed linear light to generate a planar light.

Taiwan Publication No. 200510877 discloses a backlight module. The backlight module includes a light guide plate and at least one linearity light source. The linearity light source includes a point illuminant, an optical fiber for transmitting the light beams from the point illuminant, and transparent boards for holding the optical fiber therebetween. The transparent boards are provided with micro disturbing structures. Light beams emitted from the linearity light source are transmitted to planar light through the light guide plate.

Taiwan Publication No. 200521570 discloses a backlight module. The backlight module includes a light guiding plate and at least a light source device. The light source device includes a number of point illuminants, an optical fiber coupler for transmitting the light beams from the point illuminants. The light guiding plate directs light coming from the light source device to output as a planar light.

Taiwan Publication No. 200741314 discloses an LCD apparatus. The LCD apparatus includes a backlight module and a LCD panel. The backlight module includes a first light source, a first light emitting chamber, at least a first optical fiber and a first light guiding plate. The first light emitting chamber has a first opening. The first light source is accommodated in the first light emitting chamber. One end of the first optical fiber connects to the first opening, and the other end of the first optical fiber connects to the first light guiding plate. The LCD panel is disposed adjacent to one side of the first light guiding plate.

Taiwan Publication No. 200730905 discloses an optical fiber light guiding plate structure. According to the prior art, light beams from a light source (LED/halogen lamp/bulb) are transmitted and controlled by electronic and mechanical structures. The light beams are transmitted to a predetermined plane (parallel lines, circular, regular or irregular curve lines) through a specific optical fiber. Light beams emitted from the end or side of the optical fiber are through the transparent glass sheet (plate) or acrylic sheet (plate) to show the patterns or words carved in the glass sheet (plate) or acrylic sheet (plate). Thus the function of illumination and decoration is realized.

After a comprehensive survey of the abovementioned patents, it is found that those disclosures still suffer problems of numerous components, complicated structure, inferior heat-dissipating efficiency, and light mura. Therefore an edge lighting BLU is provided by the present invention to decrease the amounts of the components required by the BLU, and thus to improve reliability of the product. Furthermore, by dislocating the light-heat source to sides of the BLU, not only the convenience of thermal management is improved, but also the light mura is substantially avoided.

The present invention provides an edge lighting BLU. The edge lighting BLU includes two light emitting devices (LEDs), an optical fiber and a light guide plate. The two LEDs are positioned respectively at two ends of the optical fiber. It is noteworthy that a plurality of micro-structures is formed on the optical fiber for breaking the total reflection of light inside the optical fiber, thus when the light emitted from the optical fiber, an uniformly linear illuminant is obtained. Furthermore, the optical fiber is positioned at a side of the light guide plate, when the light is uniformly emitted from the optical fiber, the light guide plate is to uniformly reflect the light and transform it to form a uniformly planar illuminant which is required by the LCD.

The abovementioned micro-structures can be protruded from a surface of the optical fiber or caved into the surface of the optical fiber. And the shape of the micro-structure is semicircle, V-shape or polyhedral cone, or is irregular in shape. The micro-structures are formed on the surface of the optical fiber by injection-molding, electro chemical discharge machining (ECDM), laser beam machining (LBM), glass molded or sand blasting.

To make the optical fiber able to emit light uniformly, a spatial distribution of the micro-structures is corresponding to a luminous intensity distribution of the light from the LEDs in the optical fiber. For example, when the micro-structures are identical with each other, which mean the shape, the size and the curve surface radian of the micro-structures are all identical, a density distribution of the micro-structures is inversely proportional to the luminous intensity distribution of the light in the optical fiber. It is found that light is slight at portions distal to the LEDs in the optical fiber, therefore density of the micro-structures is increased to improve transmission efficiency and thus to improve the uniformity of the light emitted from the optical fiber.

Additionally, uniformity of the light also can be improved by providing micro-structures having different areas. In the same concept, light is slight at portions distal to the LEDs in the optical fiber, therefore micro-structures in the portion are provided with larger area to improve the transmission efficiency and thus to improve uniformity of the light emitted from the optical fiber.

Nevertheless, the BLU is not limited to adopt only one LED. With properly corresponding spatial distribution of the micro-structures, a linear illuminant emitting uniform light is still obtained. The BLU is not limited to adopt four optical fibers around the light guide plate to improve the luminance, instead of using only one optical fiber as the linear illuminant. Additionally, besides the optical fiber, column-shaped light guide unit comprising Polymethylmethacrylate (PMMA) or Polycarbonate (PC) can be adopted in the BLU of the present invention.

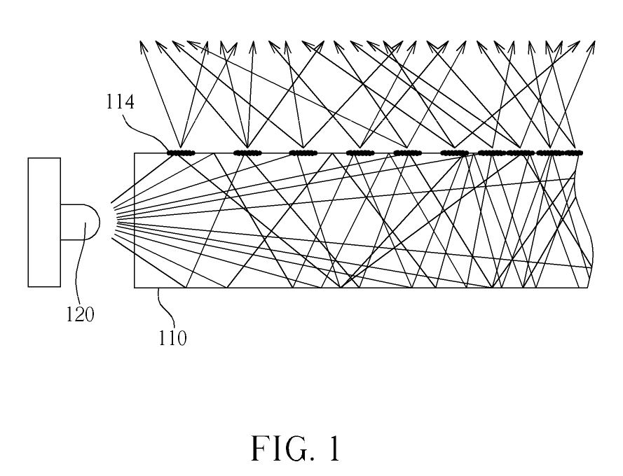

Please refer to FIG. 1. The present invention provides a light guide unit 110 of a BLU. The light guide unit 110 includes a plurality of micro-structures 114 for breaking the total reflection of light inside the light guide unit 110 to generate a light illuminating outside the light guide unit 110. A spatial distribution of the micro-structures 114 is determined correspondingly by the luminous intensity distribution of light from at least a point illuminant 120 in the light guide unit 110. Thus the point illuminant 120 is transformed into a linear illuminant emitting uniform light.

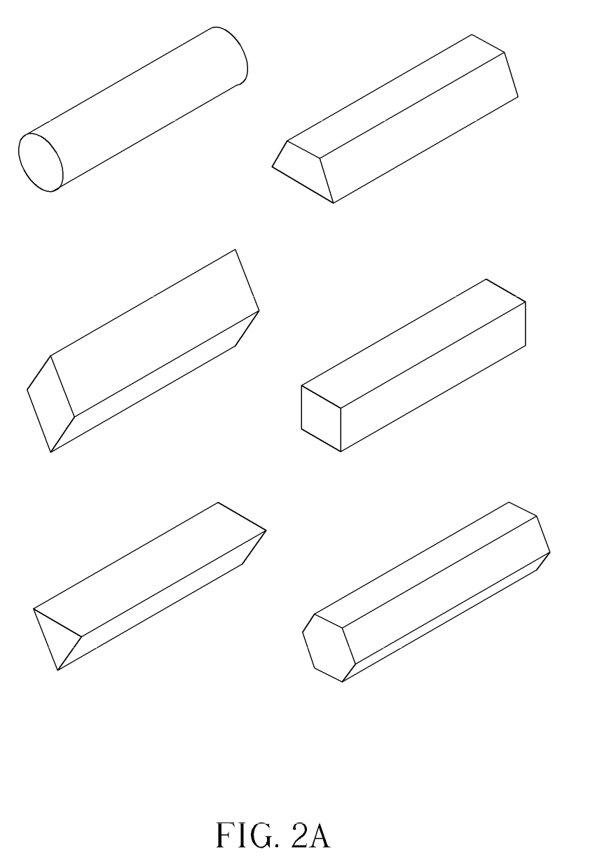

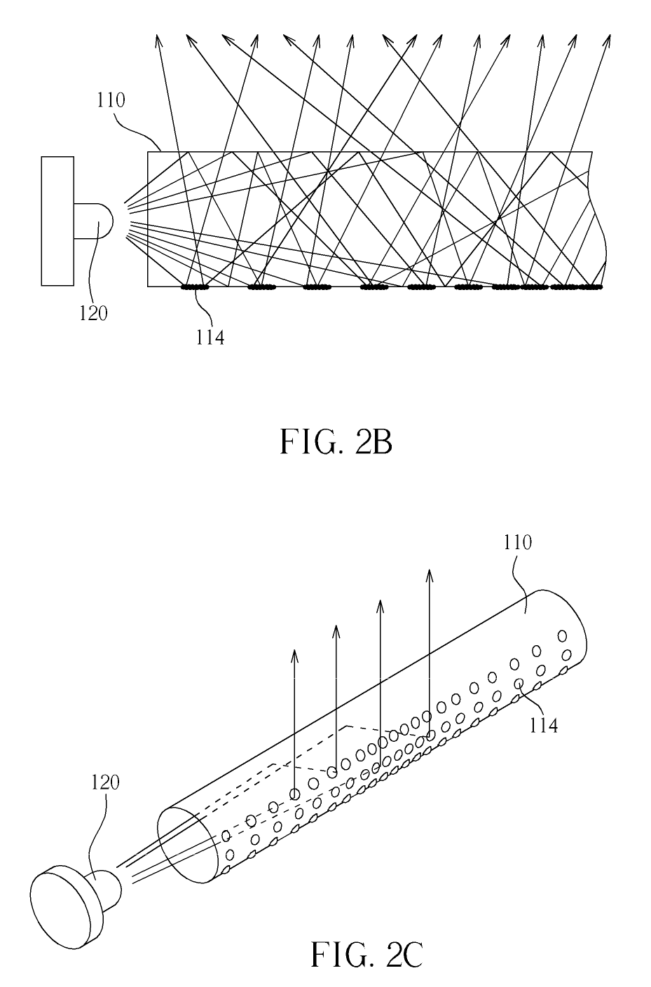

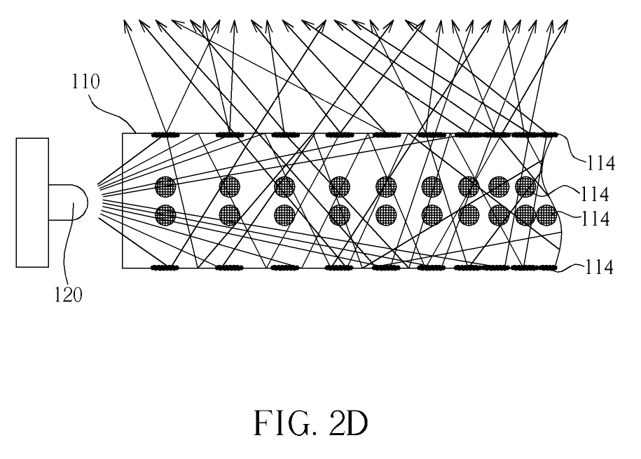

The light guide unit 110 can be a column-shaped light guide unit, and a shape of cross section of the light guide unit 110 is circle, triangle, rectangle, trapezoid, rhombus, or polygon as shown in FIG. 2A. The light guide unit 110 can be a solid or hollow column formed of optical fiber, glass, PMMA or PC.

The micro-structures 114 are distributed on the light-emitting surface of the light guide unit 110 as shown in FIG. 1 for breaking the total reflection of light inside the light guide unit 110 to generate light directly emitting out from the light guide unit 110. Or, as shown in FIG. 2B, the micro-structures 114 are distributed on a reflecting surface of the light guide unit 110 for changing the reflection path of light and thus the light is transmitted out from the light-emitting surface of the light guide unit 110. Please further refer to FIG. 2C. The micro-structures 114 can be distributed on side surface of the light guide unit 110 for changing the reflection path of light, and thus light is transmitted out from the light-emitting surface of the light guide unit 110. The micro-structures 114 can be distributed on the light-emitting surface, the reflecting surface and the side surface of the light guide unit 110 to improve the light extraction efficiency of the light guide unit 110 as shown in FIG. 2D.

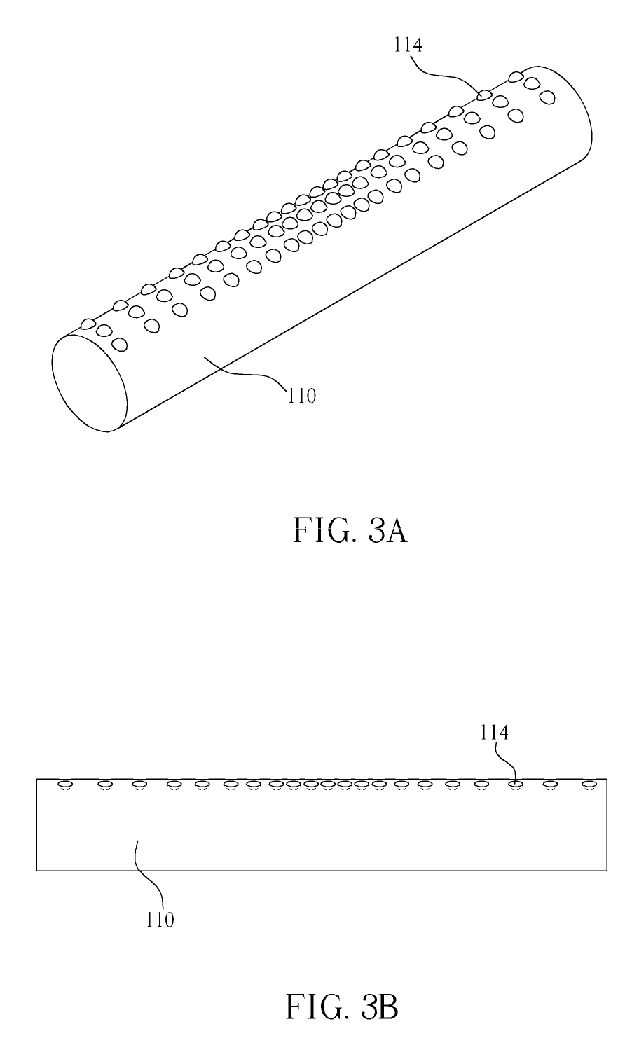

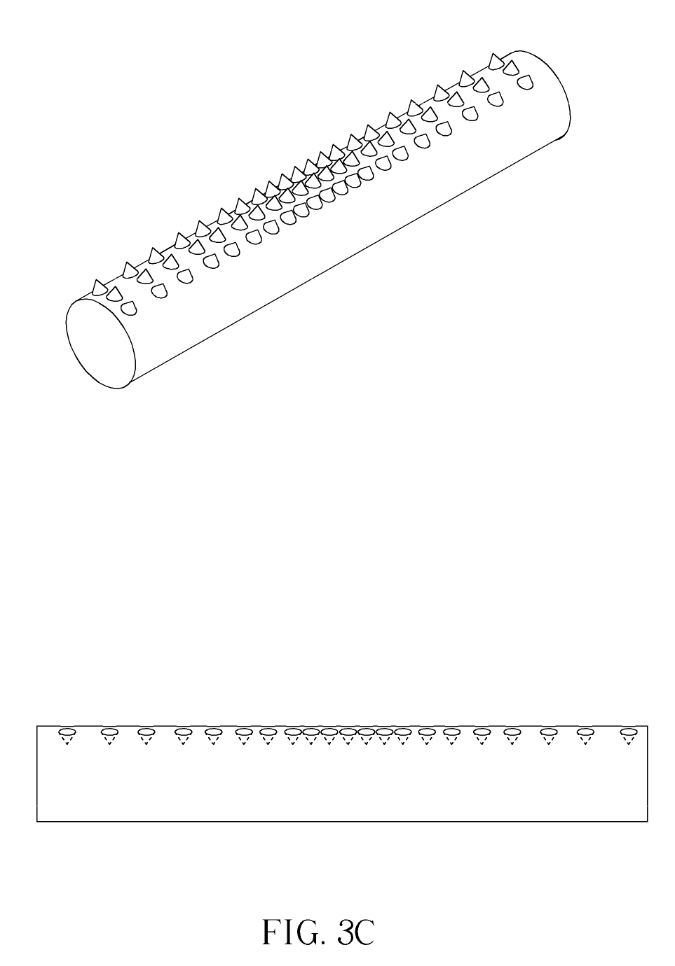

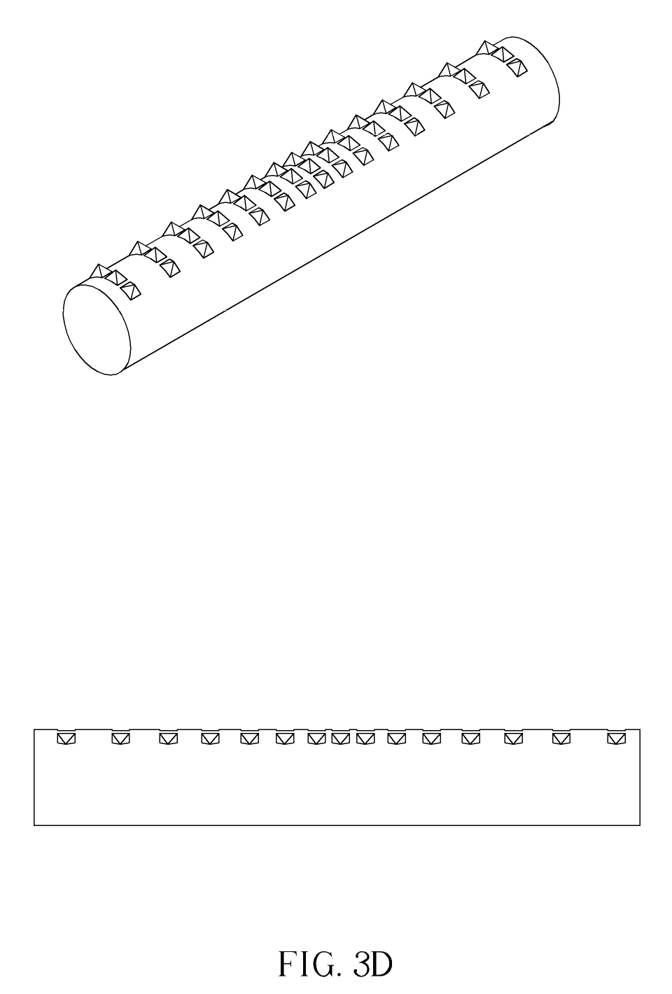

It is noteworthy that the micro-structures 114 distributed in different portions of the light guide unit 110 possess different optical purposes (transmission or reflection). For example, the micro-structures 114 positioned on the light-emitting surface of the light guide unit 110 are used to transmit light directly while the micro-structures 114 positioned on the reflection surface and side surface of the light guide unit 110 are used to reflect light. Accordingly, the micro-structures 114 can be protruded from the surface of the light guide unit 110 as shown in FIG. 3A; the micro-structures 114 also can be caved into the surface of the light guide unit 110 as shown in FIG. 3B. The shape of the micro-structure 114 can be semicircle as shown in FIGS. 3A and 3B, V-shape as shown in FIG. 3C, or polyhedral cone as shown in FIG. 3D, or be irregular shape to realize its optical purposes. To form the micro-structures 114 with the shape as mentioned above on the light guide unit 110 of different materials, the micro-structures 114 are formed by injection-molding, ECDM, LBM, glass molded, or sand blasting.

To make the light guide unit 110 able to emit light uniformly, the spatial distribution of the micro-structures 114 is corresponding to a luminous intensity distribution of light from the point illuminant 120 in the light guide unit 110. For example, when the micro-structures 114 are identical with each other, which means the micro-structures 114 have the same shape, the same size and the same curve surface radian, the density distribution of the micro-structures 114 is inversely proportional to the luminous intensity distribution of light from the point illuminant 120 in the light guide unit 110. It is found that light is slight in the light guide unit 110 where is distal to the point illuminant 120, therefore density of the micro-structures 114 is increased to improve transmission efficiency and thus to improve the uniformity of the light emitted from the light guide unit 110, as shown in FIG. 1.

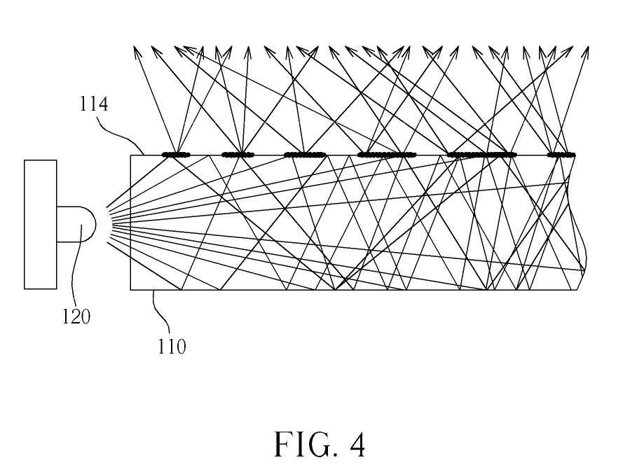

Additionally, uniformity of the light also can be improved by providing micro-structures 114 having different areas. In the same concept, light is slight in the light guide unit 110 where is distal to the point illuminant 120, therefore micro-structures 114 in the portion are provided with larger area to improve the transmission efficiency and thus to improve uniformity of the light emitted from the light guide unit 110 as shown in FIG. 4.

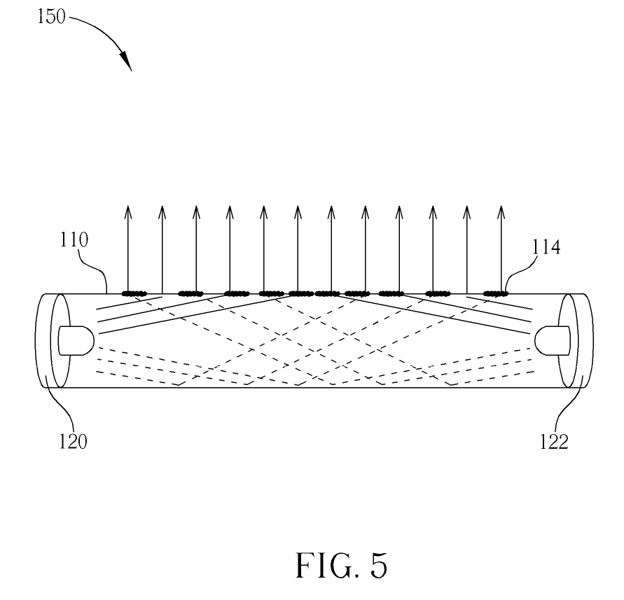

Please refer to FIG. 5. The present invention also provides a linear illuminant 150. The line illuminant 150 includes at least a point illuminant 120 and the light guide unit 110 as mentioned above. And the micro-structures 114 as mentioned above are unevenly distributed on the light guide unit 110 for breaking the total reflection inside the light guide unit 110 to generate light uniformly emitting outside the light guide unit 110. The linear illuminant 150 further includes another point illuminant 122 positioned on an opposite end of the light guide unit 110 for improving the light extraction of the linear illuminant 150. The above mentioned point illuminants 120, 122 can be LEDs, but not limited to this.

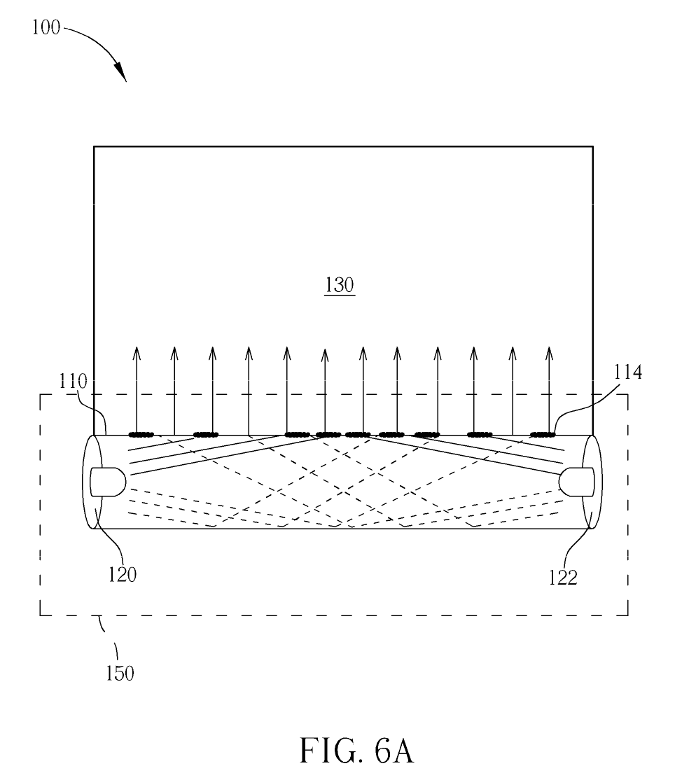

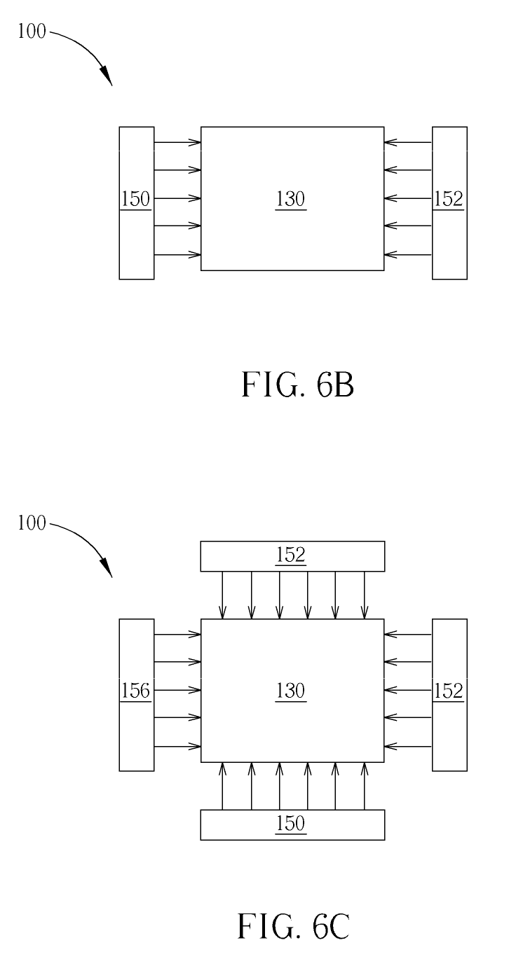

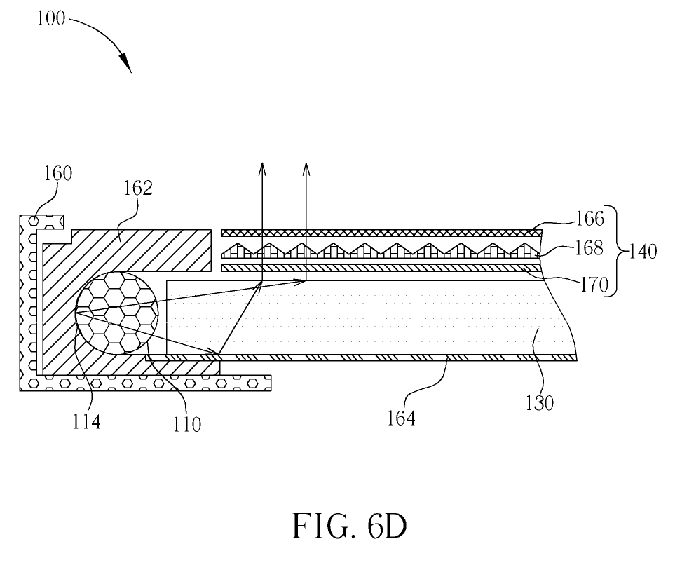

Please refer to FIG. 6A. The present invention further provides an edge lighting BLU 100. The edge lighting BLU 100 includes the linear illuminant 150 as mentioned above and a light guide plate 130. The linear illuminant 150 can be positioned on a side of the light guide plate 130. The light guide plate 130 is to reflect light emitted from linear illuminant 150, thus the linear illuminant 150 is transformed into a uniformly planar illuminant.

To improve the light extraction efficiency of the plate illuminant, the BLU 100 further includes two line illuminants 150, 152 respectively positioned at two opposite sides of the light guide plate 130 as shown in FIG. 6B. The BLU 100 is not limited to include four line illuminants 150, 152, 154 and 156 respectively positioned around the light guide plate 130 as shown in FIG. 6C to improve the luminance of the BLU.

Please refer to FIG. 6D, which is a cross section diagram showing an edge lighting BLU 100. The edge lighting BLU 100 includes a conventional optical film 140, a back bezel 160, a reflector holder 162, a reflector 164, an up diffuser 166, a brightness enhancement film (BEF) 168 and a down diffuser 170. The light source is a LED. The micro-structures 114 in the column-shaped light guide unit 110 render physical mechanism for breaking the total reflection of light. Thus light transmitted from the light guide unit 110 is guided by the light guide plate 130 and reflected by the reflector 164 to form a uniformly planar illuminant for the BLU 100 adopted in the LCD.

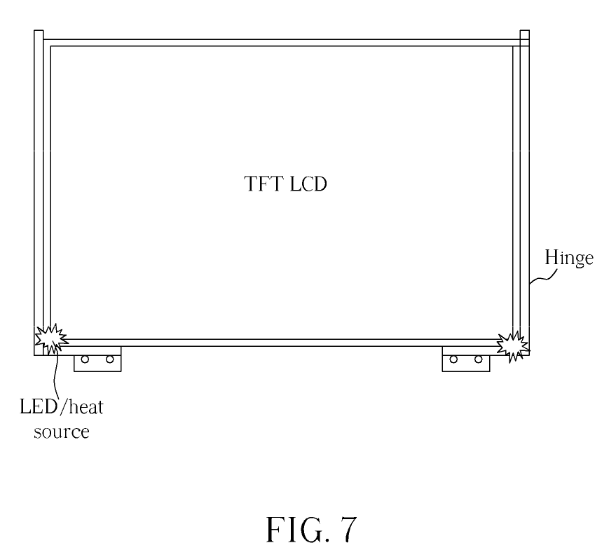

Accordingly, the BLU provided by the present invention includes light guide unit having simple structure and less number of point illuminants, therefore component failure rate is decreased. By positioning the point illuminant at one side, two sides or four side of the LCD and connecting with the metal parts of the system structure, it is more convenient to position the heat dissipation device and to improve thermal dissipation efficiency as shown in FIG. 7. Furthermore, the column-shaped light guide unit of the present invention is to form a linear illuminant emitting uniform light, which is introduced into the light guide plate. And thus a planar illuminant emitting uniform light is obtained through the light guide plate. Accordingly, light mura is prevented, and the display reliability of the LCD is improved.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Those skilled in the art will readily observe that numerous modifications and alterations of the device and method may be made while retaining the teachings of the invention.

What is claimed is:

1. A light guide unit of a back light unit (BLU) comprising a plurality of micro-structures for breaking the total reflection inside the light guide unit to generate light illuminating outside the light guide unit, wherein a spatial distribution of the plurality of micro-structures is corresponding to a luminous intensity distribution of light from a point illuminant in the light guide unit for transforming the point illuminant to a uniformly linear illuminant.

2. The light guide unit of claim 1, wherein the light guide unit is a column-shaped light guide unit, and a shape of cross section of the light guide unit is circle, triangle, rectangle, trapezoid, rhombus, or polygon.

3. The light guide unit of claim 1, wherein the micro-structures are protruded from a surface of the light guide unit or caved into the surface of the light guide unit.

4. The light guide unit of claim 3, wherein the shape of the micro-structure is semicircle, V-shape or polyhedral cone, or is irregular shape.

5. The light guide unit of claim 1, wherein an area of each micro-structure is inversely proportional to the luminous intensity distribution in the light guide unit.

6. The light guide unit of claim 1, wherein the micro-structures are identical with each other, and a spatial distribution of the micro-structures is a density distribution of the micro-structures.

7. The light guide unit of claim 6, wherein the density distribution of micro-structures is inversely proportional to the luminous intensity distribution in the light guide unit.

8. The light guide unit of claim 1, wherein the micro-structures are formed by Injection-Molding, Electro Chemical Discharge Machining (ECDM), Laser Beam Machining (LBM), glass molded, or sand blasting.

9. A linear illuminant comprising:
at least a point illuminant; and
a light guide unit having a plurality of micro-structures for breaking the total reflection inside the light guide unit to generate a uniform light illuminating outside the light guide unit;
wherein a spatial distribution of the plurality of micro-structures is corresponding to a luminous intensity distribution of light from a point illuminant in the light guide unit.

10. The linear illuminant of claim 9, wherein the light guide unit is a column-shaped light guide unit, and a shape of cross section of the column-shaped light guide unit is circle, triangle, rectangle, trapezoid, rhombus, or polygon.

11. The linear illuminant of claim 10, wherein the point illuminant emits light into an end of the light guide unit.

12. The linear illuminant of claim 9, wherein the micro-structures are protruded from a surface of the light guide unit or caved into the surface of the light guide unit, and the shape of the micro-structure is semicircle, V-shape or polyhedral cone, or is irregular shape.

13. The linear illuminant of claim 9, wherein an area of each micro-structure is inversely proportional to the luminous intensity distribution in the light guide unit.

14. The linear illuminant claim 9, wherein the micro-structures are identical with each other, and the density distribution of micro-structures is inversely proportional to the luminous intensity distribution in the light guide unit.

15. An edge lighting back light unit (BLU) comprising:
at least a point illuminant;
a light guide unit having a plurality of micro-structures for breaking the total reflection inside the light guide unit to generate a light illuminating outside the light guide unit, wherein a spatial distribution of the plurality of micro-structures is corresponding to a luminous intensity distribution of light from the point illuminant to transform the point illuminant into a uniformly linear illuminant; and
a light guide plate for transforming the linear illuminant to a planar illuminant.

16. The edge lighting BLU of claim 15, wherein the light guide unit is a column-shaped light guide unit and a shape of cross section of the light guide unit is circle, triangle, rectangle, trapezoid, rhombus, or polygon.

17. The edge lighting BLU of claim 16, wherein the micro-structures are protruded from a surface of the light guide unit or caved into the surface of the light guide unit, and the shape of the micro-structure is semicircle, V-shape or polyhedral cone, or is irregular shape.

18. The edge lighting BLU of claim 17, wherein the point illuminant emits light into an end of the light guide unit, and an area of each micro-structure is inversely proportional to the luminous intensity distribution in the light guide unit.

19. The edge lighting BLU of claim 17, wherein the micro-structures are identical with each other and the density distribution of micro-structures is inversely proportional to the luminous intensity distribution in the light guide unit.

20. The edge lighting BLU of claim 15, wherein the light guide unit is positioned on a side of the light guide plate.
